(19) United States
(12) Patent Application Publication
(10) Pub. No.: US 2010/0283228 A1
(43) Pub. Date: Nov. 11, 2010

(54) Caster for Stroller-Cycle

(75) Inventors: Michael Ehrenreich, South Orange, NJ (US); Joel Hoag, Brooklyn, NY (US); Brian Rhee, New York, NY (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: SOMA CYCLE, INC., South Orange, NJ (US)

(21) Appl. No.: 12/773,399

(22) Filed: May 4, 2010

Related U.S. Application Data
(60) Provisional application No. 61/175,526, filed on May 5, 2009.

(51) Int. Cl. B62B 7/04; B60B 33/00

(52) U.S. Cl. 280/647; 16/35 R; 16/45

(57) ABSTRACT

An openable caster having a mount cap, a mount housing pivotally connected to the mount cap, a post protruding from a top surface of the mount housing, a switch disposed on the mount cap and a slide release mechanism for locking and releasing the caster. The slide release mechanism has a flange disposed within the mount cap. The flange includes a recess with a bracket, the bracket being accessible from an underside of the mount housing. The flange is operationally connected to the switch. Actuation of the switch moves the slide release mechanism from a locked state, in which the caster is closed and a portion of the post is secured by the bracket, to a released state in which the post is released from the bracket.

### BACKGROUND OF THE INVENTION

1. Field of Invention

The present invention relates to a vehicle for pushing and riding, e.g., a stroller-cycle and more particularly, to casters that may be used on the same. This application claims priority to U.S. Provisional Application No. 61/175,526.

2. Description of Related Art

Often, vehicles or other traveling bodies that lack directional steering, e.g., strollers, shopping carts or office chairs, include wheels that are adapted to rotate freely about a vertical axis. Without this feature, such vehicles could not be easily turned or moved along a curved path.

A wheel arrangement known for pivoting a wheel, particularly wheels used on traveling bodies such as strollers, is a caster wheel. A caster wheel generally includes a wheel having an axle (which defines the wheel's axis of rotation). The wheel is mounted to a wheel mount, which is pivotable about a vertical pivot axis, with the wheel's axle offset horizontally from the wheel mount's pivot axis. This geometry provides a stable arrangement in which the wheel's axle will tend to trail the pivot axis when a horizontal motive force is applied to the mount, the axle tending to align perpendicularly to the direction of motion (and thus to intersect the center of motion). In the case of a stroller, for example, the front wheels are often pivotable caster wheels and the rear wheels are fixed, which allows the stroller to be easily steered by a user.

In some embodiments, a traveling body, e.g., a stroller, may include a feature in which caster wheels affixed thereto can be adjusted from an operational position to a non-operational position. A user may desire to adjust the caster wheels into a non-operational position, e.g., if the stroller is used as a pushing section of a convertible stroller-cycle, such as that described in U.S. Pat. Pub. Nos. 2009/0072520 (Ehrenreich, et. al.) and 2010/0032925 (Ehrenreich, et. al.), which are incorporated herein by reference in their entireties.

U.S. Pat. Pub. No. 2010/0032925 describes an exemplary caster pivot mechanism that enables the caster wheel to be adjusted from an operational position to a non-operational position. The casters of the pushing section, or stroller described in U.S. Pat. Pub. No. 2010/0032925, may experience significant vibrational, load bearing and impact related stresses when in use. The casters are therefore optimally constructed of materials resistive to wear and tear. Wear and tear of openable casters may also be reduced by including features that securely lock such casters in a closed position when in use.

### BRIEF SUMMARY OF THE INVENTION

In accordance with the present invention, there is provided an openable caster adapted to be securely locked in a closed position and readily unlocked and opened by a user. The caster includes a mount cap, a mount housing pivotally connected to the mount cap, a post protruding from a top surface of the mount housing, a switch disposed on the mount cap and a slide release mechanism for locking and releasing the caster. The slide release mechanism has a flange disposed within the mount cap. The flange includes a recess with a bracket, the bracket being accessible from an underside of the mount housing. The flange is operationally connected to the switch. Actuation of the switch moves the slide release mechanism from a locked state, in which the caster is closed and a portion of the post is secured by the bracket, to a released state in which the post is released from the bracket.

### BRIEF DESCRIPTION OF THE DRAWING

The invention will be described in conjunction with the following drawing in which like reference numerals designate like elements and wherein:

FIG. 1 shows an exemplary fully assembled vehicle for pushing and riding, e.g., a stroller-cycle;

FIG. 2 shows an exemplary pushing section of the vehicle of FIG. 1.

FIGS. 3A-3G show an embodiment of a caster for the pushing section of the vehicle of FIG. 1.

FIG. 4 shows an isometric view of an exemplary caster for the pushing section of the vehicle of FIG. 1, the caster being in a closed position.

FIG. 5 shows a an isolated isometric view of the mount cap of the caster of FIG. 4, wherein a front portion thereof is cut out, revealing components of a slide release mechanism therein.

FIG. 6 shows a front view of the caster of FIG. 4 in an open position.

FIG. 7 is an isometric view of the caster in a closed position wherein the slide release mechanism is in a locked state.

### DETAILED DESCRIPTION OF THE INVENTION

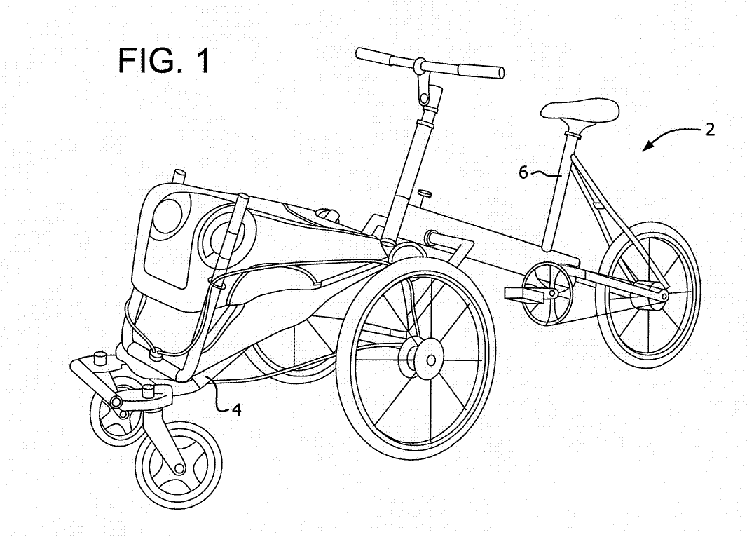

Referring to FIG. 1, there is shown an exemplary vehicle 2 for pushing and riding, e.g., a convertible stroller-cycle. The vehicle 2 has a pushing section 4 comprising a stroller for a passenger and a riding section 6 comprising a cycle for a rider. As explained in U.S. Pat. Pub. Nos. 2009/0072520 and 2010/0032925, the pushing section 4 and riding section 6 may be operated independently of one another. That is, the pushing section 4 may be used as a stroller that can be pushed by a user while walking or running and the riding section 6 may be operated independently as a cycle.

The separate pushing section 4 and riding section 6 may be easily and quickly coupled to one another and thus converted into to the vehicle 2 without tools, in the manner described in U.S. Pat. Pub. Nos. 2009/0072520 and 2010/0032925, so that a rider on the riding section 6 may transport a passenger on the pushing section 4. The vehicle 2 may also be easily separated without tools, in the manner described in U.S. Pat. Pub. Nos. 2009/0072520 and 2010/0032925, so that the pushing section 4 and riding section 6 may be used separately.

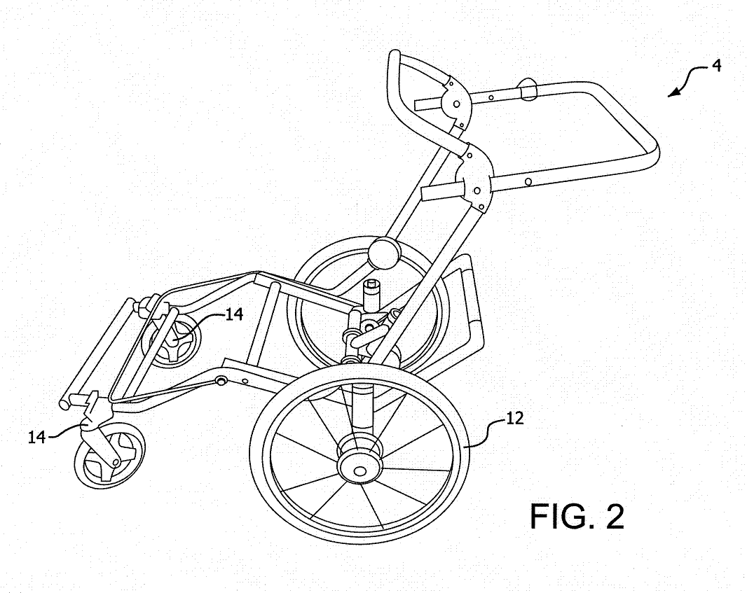

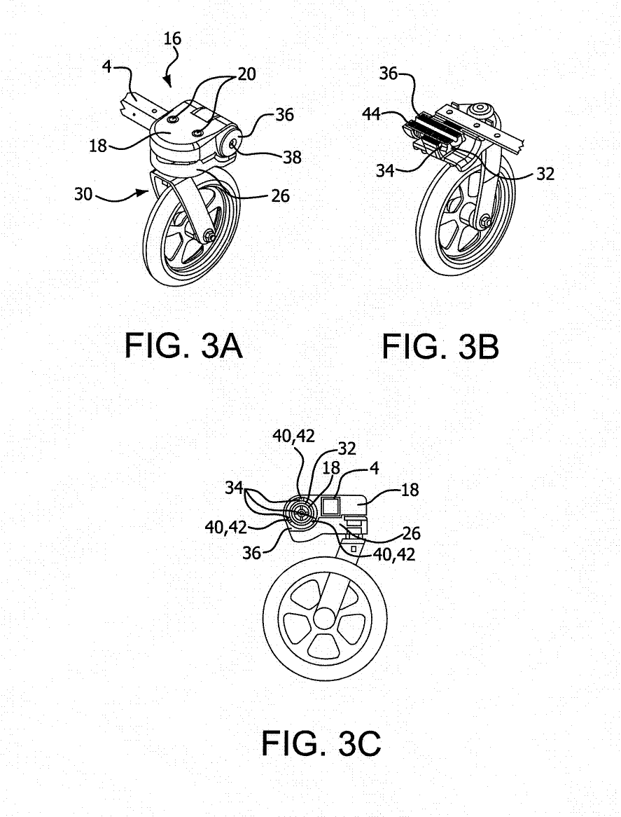

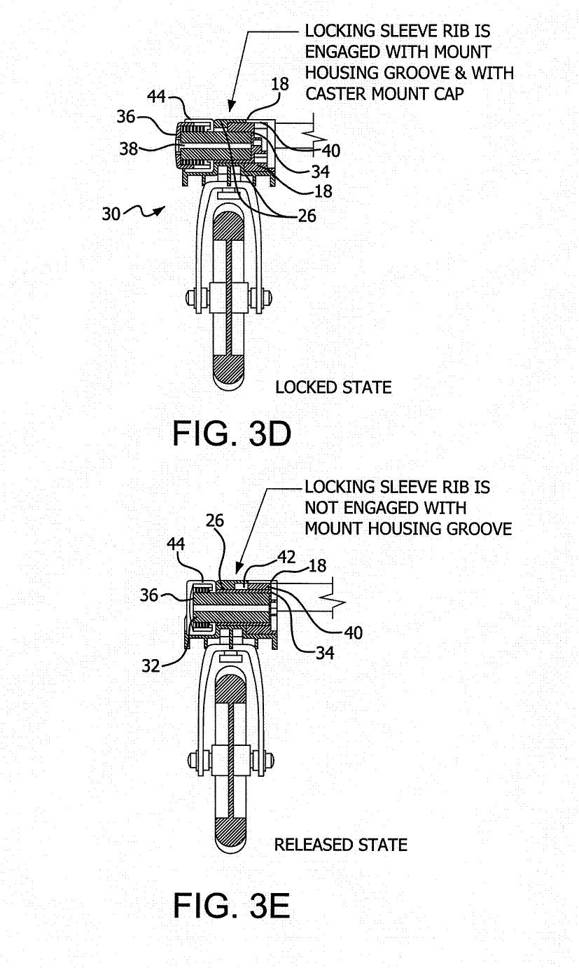

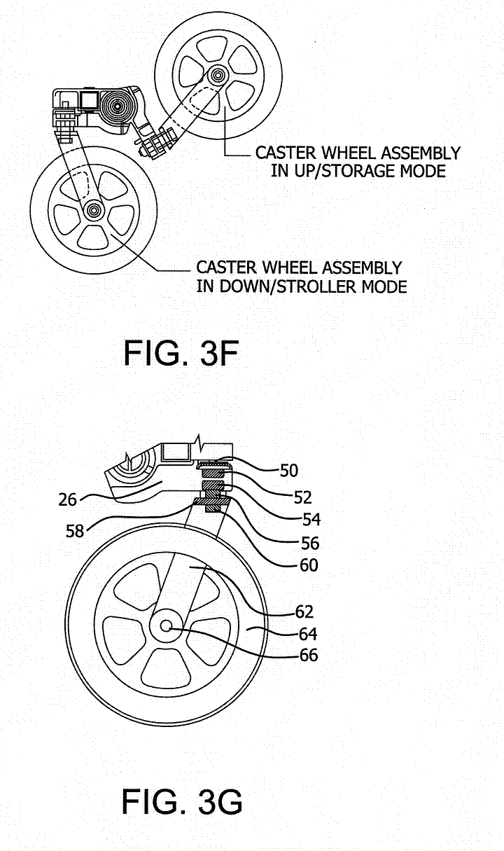

Referring now to FIG. 2, there is shown an exemplary pushing section 4 of the vehicle 2 of FIG. 1. The pushing section 4 includes a pair of wheels 12 towards the rear thereof and a pair of casters 14 towards the front thereof, the casters 14 balancing the pushing section 4 when the pushing section 4 is operated separately from the riding section 6. The casters 14 are pivotable for operation (i.e., for stroller use) and non-operation (i.e., for cycle use) with a push-button caster pivot mechanism 16, as shown in FIGS. 3A-3G.

Referring to FIG. 3A, the caster pivot mechanism 16 may include a caster mount cap 18 that rigidly attaches to a portion of the frame of the pushing section 4 using bolts or rivets 20, for example. A caster mount housing 26 may be pivotally connected to the caster mount cap 18 and have the caster wheel assembly 30 affixed thereto. The caster mount housing 26 may pivot about a caster locking sleeve 32 (see, e.g., FIGS. 3B and 3C).

As shown in FIGS. 3A-3C, the caster locking sleeve 32 may comprise locking sleeve ribs 34 and be attached to a pushbutton 36 by a bolt 38. Any means of attachment may be used including a rivet, press-fit, or adhesives, for example. As shown in FIG. 3C, the caster locking sleeve 32 may comprise three ribs 34 equally spaced circumferentially around a central axis. The ribs 34 may extend axially a predetermined distance from a peripheral end of the locking sleeve 32 opposite the pushbutton 36. As shown in FIG. 3C, when in a locked position, the ribs 34 on the caster locking sleeve 32 engage grooves 40 in the caster mount cap 18 and grooves 42 in the caster mount housing 26. As shown in FIG. 3D, the caster pivot mechanism 16 may be maintained in a locked position by engagement of the ribs 34 in the caster mount housing 26 through use of a biasing mechanism 44, which may be a spring, coil, and the like, that exerts outward pressure on the pushbutton 36.

As shown in FIG. 3E, the pushbutton 36 may be pressed inward to release the ribs 34 from the grooves 42 in the caster mount housing 26. The ribs 34 slide out of the grooves 42 allowing the caster mount housing 26, with the caster wheel assembly 30 attached, to pivot freely around the axis of the locking sleeve 32. In this manner, the locking sleeve 32 serves as the pivot axle for the caster mount housing 26. The locking sleeve 32 does not rotate as it is held firmly by the ribs 34 that extend into the grooves 40 (shown in dotted lines) in the rigidly fixed mounting cap 18. The ribs 34 always remain engaged in the grooves 40 of the mounting cap 18.

As shown in FIG. 3F, with the caster mount housing 26 free to rotate around the pivot point, a user can turn the caster mount housing and the attached caster wheel assembly to the “storage” position where it will lock in place. The biasing mechanism 44 continues to exert outward pressure on the pushbutton 36 and the locking sleeve 32, which forces the ribs 34 to re-engage grooves 42 in the caster mount housing 26 that align when the caster mount housing 26 is rotated to the “storage” position. The caster pivot mechanism 16 remains in the locked “storage” position until a user presses the pushbutton 36 to disengage the ribs 34 and allow rotation of the caster mount housing 26 in the reverse direction to the “operational” position.

FIG. 3G illustrates the caster wheel assembly 30. The wheel assembly 30 may be attached to the caster mount housing 26 by a mounting post 50 that slides through an upper bearing 52, an aperture in the caster mount housing 26, a lower bearing 54, a spacer 56, and an aperture in a horizontal portion of the caster fork 58. The mounting post 50 may have a threaded end to secure the assembly with a mounting nut 60. The spacer 56 provides clearance of the caster fork 58 from the caster mount housing 26. Washers may be provided between one or more of the parts of the caster wheel assembly 30 to prevent damage and wear. The caster fork 58 has two fork arms 62 that extend vertically from the horizontal portion of the caster fork 58. The fork arms 62 are supported on each side of the caster wheel 64 by an axle 66 that extends horizontally through holes or slots provided near the free ends of the fork arms 62 and the center hub of the caster wheel 64. Nuts or axle caps, for instance, secure the axle in place with the caster wheel 64 centered between the fork arms 62 of the caster fork 58. The fork arms 62 may be formed to extend vertically at a predetermined angle when measured from the center axis of the mounting post 50. In this manner, the caster fork 58 and mounting post 50 are free to rotate by way of bearings 52, 54 so that the caster wheel 64 may easily follow any direction of motion when the pushing section 4 is a stroller and is being pushed.

For example, as shown in FIG. 3F, when the pushing section 4 is a stroller and operates separately from the riding section 6, the casters 14 are pivotable downward and locked in the operational state to balance the stroller. When the pushing section 4 is combined with the riding section 6, the casters 14 are pivotable upward and may be locked in a non-operational, or storage, state as also shown in FIG. 3F.

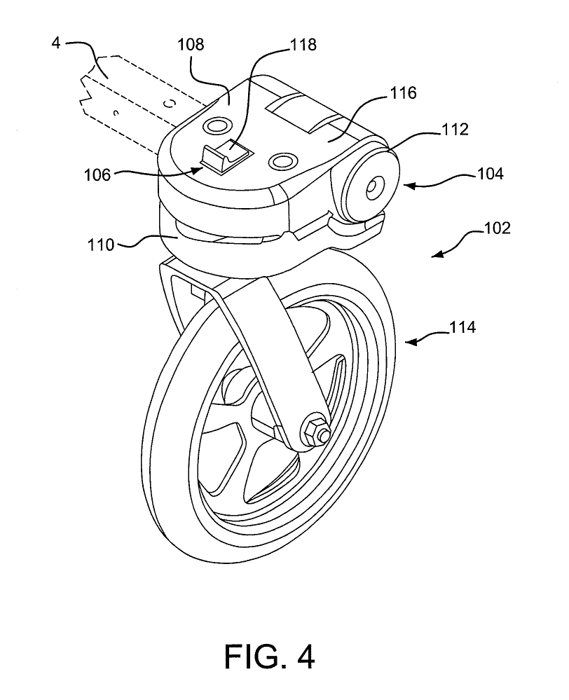

In an alternative embodiment, a caster 102, as shown in FIG. 4, preferably includes a push-button caster pivot mechanism 104 such as that shown in FIGS. 3A-3G and described above. That is, the caster 102 preferably comprises a push button caster pivot mechanism 104 that includes the same components and operates in the same way as the push button caster pivot mechanism 16 discussed above. In addition, the caster 102 includes a slide release mechanism 106. The caster 102 may be pivoted from an operational position (i.e., for stroller use) to a non-operational position (i.e., for cycle use) through sequential actuation of: (1) the slide release mechanism 106 and (2) the push-button caster pivot mechanism 104.

The slide release mechanism 106 functions as a secondary holding device to prevent accidental release of the push-button caster pivot mechanism 104. The slide release mechanism 106 further functions to secure the mount cap 108 to the mount housing 110 so as to reduce the stresses experienced (e.g., through vibration of the caster 102) by the push button caster pivot mechanism 104 while the caster 102 is in operation. As such, the slide release mechanism 106 provides an additional assurance that the caster 102 will not fail after repeated rigorous use and that it will comply with industry standards for safety and durability, e.g., EN 1888.

As shown in FIG. 4, the mount cap 108 is secured to a portion of the frame of the pushing section 4. The mount cap 108 and the mount housing 110 of the caster 102 are pivotally connected to one another about a caster locking sleeve 112 of the push-button caster pivot mechanism 104, the mount housing 110 having a caster wheel assembly 114 affixed thereto. The caster wheel assembly 114 of FIG. 4 may be identical to the caster wheel assembly 30 of FIG. 3F. Disposed on the top surface 116 of the mount cap 108 is a slidable switch 118 of the slide release mechanism 106.

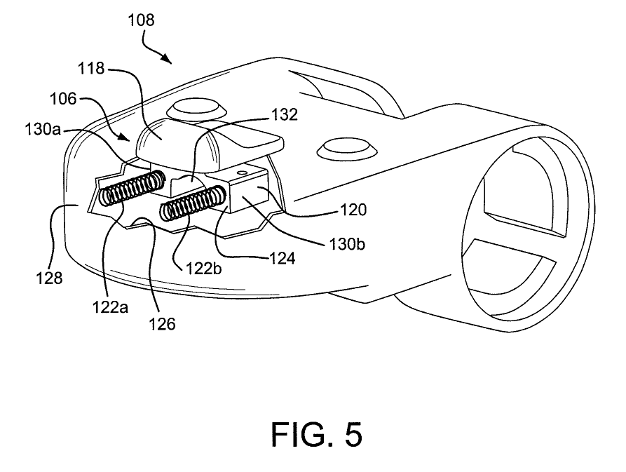

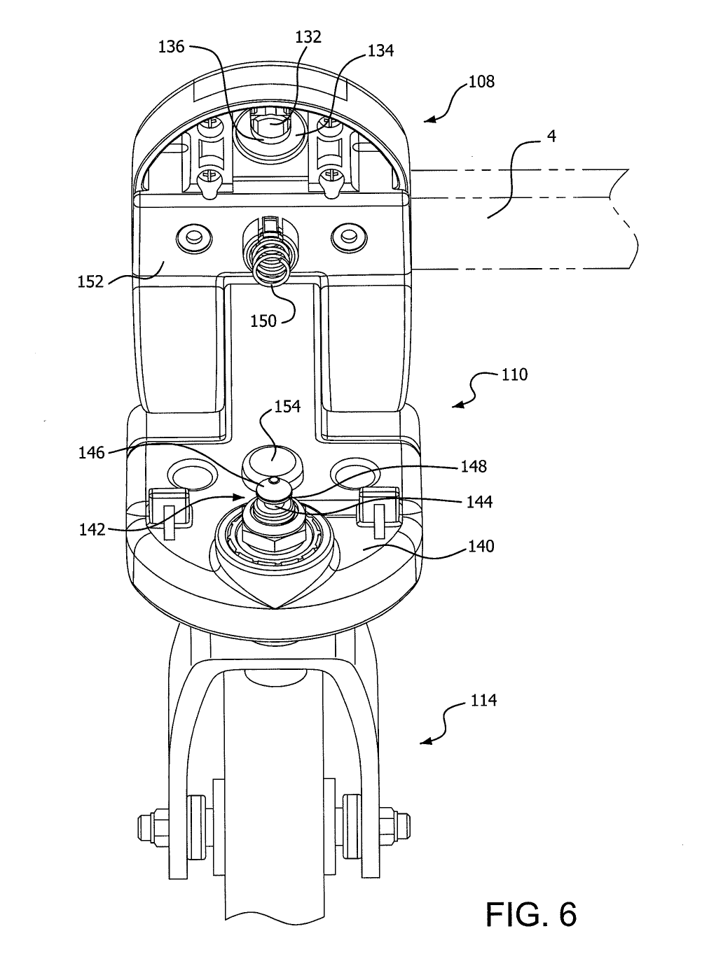

Referring now to FIG. 5, there is shown an isolated isometric view of the mount cap 108 wherein a portion of the same is cut out, revealing components of the slide release mechanism 106 therein. Extending downward from the underside of the slidable switch 118 is a flange 120. Two springs 122a, b are disposed between the front surface 124 of the flange 120 and the inner wall 126 of the front surface 128 of the mount cap 108. The springs 122a, b apply equal and opposite force to the flange 120 and the inner wall 126 of the front surface 128 of the mount cap 108. The force applied by the springs 122a, b maintains the flange 120 in its natural, resting position (so long as no opposing force acts upon the flange 120). The flange 120 preferably includes right and left legs 130a, b defining a recess 132 there-between.

Referring now to FIG. 6, there is shown a front view of the caster 102 in an open position. Viewing the underside of the mount cap 108, there can be seen a bracket 134 having a straight rigid edge 136, the bracket 134 being disposed horizontally within the recess 132.

A user may actuate the slidable switch 118 (see FIGS. 5 and 5) by sliding it (e.g., with a thumb or finger) towards the front surface 128 of the mount cap 108. This, in turn, results in translational movement of the flange 120 and bracket 134 in the direction of the front surface 128 of the mount cap 108. When the user releases the slidable switch 118, the springs 122a, b force the slidable switch 118, flange 120 and bracket 134 back to their natural resting position.

Also shown in FIG. 6 is a top surface 140 of the mount housing 110, from which a post 142 protrudes upwards. The post 142 preferably includes a shaft 144 and a head 146, the shaft 144 preferably being integral with, and having a lesser diameter than, the head 146. The head 146 is preferably conical in shape. A ledge 148 is formed where the underside of the head 146 meets the surface of the shaft 144.

Protruding from a bottom surface 152 of the mount cap 108 is a vertical spring 150. When the caster 102 is in a closed position (e.g., as it is in FIG. 4), the spring 150 is compressed, e.g., against a protrusion 154 extending upwards from a top surface 140 of the mount housing 110. While compressed, the spring 150 provides an equal and opposite force against a top surface 140 of the mount housing 110 and a bottom surface 152 of the mount cap 108.

The slide release mechanism 106 can be in either a locked or released state. When it is locked, a user would preferably be unable to actuate the push-button caster pivot mechanism 104. If it is in a released state, a user would be able to actuate the push-button caster pivot mechanism 104.

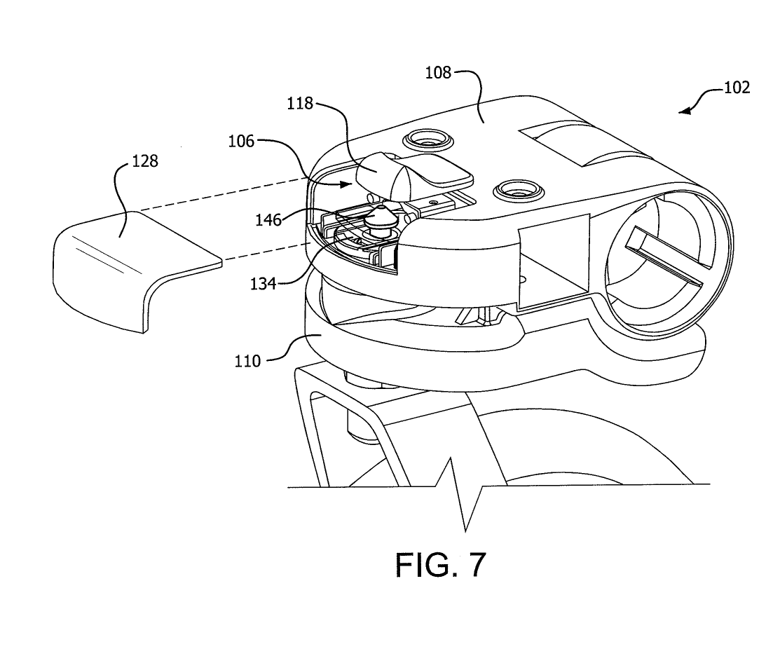

If the slide release mechanism 106 is in a released state and a user wishes to lock it, the user would pivot the mount housing 110 towards the mount cap 108 until the head 146 of the post 142 contacts the bracket 134. As the user applies pressure to the mount housing 110 towards the mount cap 108, the upward movement of the head 146 of the post 142 causes the bracket 134 to move against the force provided by the springs 122a, b (see FIG. 5). Once the head 146 fully clears the straight edge 136 of the bracket 134, the spring force pushes the straight edge 136 of the bracket 134 under the ledge 148 and against the shaft 144 of the post 142, thereby securing the post 142 within the bracket 134 and retaining the slide release mechanism 106 in a locked state. This locked state is shown in FIG. 7, which is an isometric view of the caster 102 in a closed position, wherein a portion of the front surface 128 of the mount cap 108 is exploded therefrom to show the post 142 secured within the bracket 134.

If the slide release mechanism 106 is in a locked state and a user wishes to release it, the user would actuate the slidable switch 118 as described above. This, in turn, renders the post 142 free and clear of the bracket 134 so as to place the slide release mechanism 106 in a released state. When the slide release mechanism 106 is in its released state, the force provided by the compressed vertical spring 150 helps to separate the mount housing 110 from the mount cap 108. In a like manner as that described above and shown in FIGS. 3A-3B, a user may then actuate the push-button caster pivot mechanism 104 and pivot the mount housing 110 further away from the mount cap 108, thereby moving the caster 102 from a closed position (e.g., as shown in FIGS. 4 and 7) to an open position (e.g., as shown in FIG. 6).

It should be understood that the above description and the accompanying drawing figures merely provide one example of how the present invention may be practiced and does not limit the scope of the same. One skilled in the art would appreciate that various changes and modifications can be made to the above example without departing from the spirit and scope of the present invention.

What is claimed is:

1. An openable caster comprising:
a. a mount cap;
b. a mount housing pivotally connected to the mount cap;
c. a post protruding from a top surface of the mount housing;
d. a switch disposed on the mount cap; and
e. a slide release mechanism for locking and releasing the caster, the slide release mechanism comprising a flange disposed within the mount cap, the flange having a recess with a bracket disposed therein, the bracket being accessible from an underside of the mount housing, the flange being operationally connected to the switch, whereby actuation of the switch moves the slide release mechanism from a locked state to a released state, the slide release mechanism being in the locked state when the caster is closed and a portion of the post is secured by the bracket thereby preventing the caster from opening, the slide release mechanism being in the released state when the post is released from the bracket.

2. The openable caster of claim 1 further comprising a spring disposed between the flange and an inner surface of the mount cap, the spring retaining the slide release mechanism in the locked state when the switch is not actuated.

3. The openable caster of claim 1 further comprising a wheel assembly affixed to the mount housing.

4. The openable caster of claim 2 wherein the post comprises a shaft, a head and a ledge therebetween, the slide release mechanism being in the locked state when the bracket is retained under the ledge and against the shaft of the post, thereby securing a portion of the post within the bracket.

5. The openable caster of claim 4 wherein the shaft is narrower than the head.

6. The openable caster of claim 4 wherein the switch is slidable and is disposed on a top surface of the mount cap.

7. The openable caster of claim 4, wherein the mount cap and the mount housing pivot about a locking sleeve, the locking sleeve comprising ribs that slidably engage grooves defined in the mount housing and grooves defined in the mount cap, the caster further comprising a pushbutton operationally connected to a locking sleeve, the pushbutton releasing the ribs from the grooves defined in the mount housing when actuated, thereby permitting the mount housing to pivot around the locking sleeve, the caster further comprising a biasing mechanism adapted to exert a force on the pushbutton when the pushbutton is actuated, wherein release of the pushbutton causes the biasing mechanism to force the ribs to re-engage the grooves defined in the mount housing when the mount housing rotates to a storage position.

8. The openable caster of claim 1 wherein the mount cap is affixed to a front portion of a stroller.

9. A stroller having a caster, the caster comprising:
a. a mount cap attached to a front portion of the stroller;
b. a mount housing pivotally connected to the mount cap;
c. a wheel assembly affixed to the mount housing;
d. a locking sleeve comprising ribs that slidably engage grooves defined in the mount housing and grooves defined in the mount cap;
e. a pushbutton operationally connected to the locking sleeve, the pushbutton releasing the ribs from the grooves defined in the mount housing when actuated, thereby permitting the mount housing to pivot around the locking sleeve;
f. a biasing mechanism adapted to exert a force on the pushbutton when the pushbutton is actuated, wherein release of the pushbutton causes the biasing mechanism to force the ribs to re-engage the grooves defined in the mount housing when the mount housing rotates to a storage position; and
g. a slidable switch disposed on the mount cap, the slidable switch being retained in a resting position by a spring, the slidable switch being rigidly connected to a bracket that is disposed on an underside of the mount cap, the slidable switch providing translational movement to the bracket when the slidable switch is moved, the mount housing comprising a post protruding from a top surface of the mount housing, the bracket being adapted to receive the post and lock therewith when the slidable switch is in its resting position, the post being releasable from the bracket upon movement of the slidable switch out of its resting position.

10. An openable caster comprising:
a. a mount cap;
b. a mount housing pivotally connected to the mount cap about a locking sleeve, the locking sleeve comprising ribs that slidably engage grooves defined in the mount housing and grooves defined in the mount cap;
c. a post protruding from a top surface of the mount housing, the post having a shaft, a head and a ledge therebetween, the shaft being narrower than the head;
d. a slidable switch disposed on the mount cap;
e. a wheel assembly affixed to the mount housing;
f. a pushbutton operationally connected to the locking sleeve, the pushbutton releasing the ribs from the grooves defined in the mount housing when actuated, thereby permitting the mount housing to pivot around the locking sleeve;
g. a biasing mechanism adapted to exert a force on the pushbutton when the pushbutton is actuated, wherein release of the pushbutton causes the biasing mechanism to force the ribs to re-engage the grooves defined in the mount housing when the mount housing rotates to a storage position; and
h. a slide release mechanism for locking and releasing the caster, the slide release mechanism comprising a flange disposed within the mount cap, the flange having a recess with a bracket disposed therein, the bracket being accessible from an underside of the mount housing, the flange being operationally connected to the switch, whereby actuation of the switch moves the slide release mechanism from a locked state to a released state, there being a spring disposed between the flange and an inner surface of the mount cap, the spring retaining the slide release mechanism in the locked state when the switch is not actuated, the slide release mechanism being in the locked state when the caster is closed and the bracket is retained under the ledge and against the shaft of the post, thereby securing a portion of the post within the bracket and preventing the caster from opening, the slide release mechanism being in the released state when the post is released from the bracket.

11. The openable caster of claim 10, wherein the mount cap is affixed to a front portion of a stroller.
